(19) United States
(12) Patent Application Publication
(10) Pub. No.: US 2019/0104730 A1
(43) Pub. Date: Apr. 11, 2019

(54) INSECT REPELLANT JEWELRY

(71) Applicant: Wood Originals, LLC, Bremerton, WA (US)

(72) Inventor: Monica S. Wood, Bremerton, WA (US)

(21) Appl. No.: 16/155,647

(22) Filed: Oct. 9, 2018

Related U.S. Application Data
(60) Provisional application No. 62/570,759, filed on Oct. 11, 2017.

(51) Int. Cl. A01N 25/08; A01N 65/28; A01M 29/12; A44C 15/00; A44C 5/00; A44C 9/00; A44C 7/00

(52) U.S. Cl. CPC A01N 25/08; A01N 65/28; A01M 29/12; A44C 15/002; A44C 15/0085; A44C 9/0053; A44C 15/005; A44C 7/00; A44C 5/0007

(57) ABSTRACT

An insect repellent system including a jewelry item, wherein the jewelry item includes at least one bead adaptable to at least one of adsorb and absorb at least one essential oil. The at least one essential oil is capable of repelling at least one insect and is present in an effective amount to repel the at least one insect. The system may further include a dish for receiving the jewelry item and the at least one essential oil. The jewelry item is placed in contact with the at least one essential oil in the dish.

### PRIORITY CLAIM

This application claims the benefit of and priority to U.S. Provisional Patent Application No. 62/570,759 entitled Insect Repellant Jewelry filed on Oct. 11, 2017, which is incorporated in its entirety for all purposes by this reference.

### FIELD

The present application relates to a jewelry item and, more particularly, a jewelry item that in conjunction with repellant compositions, such as at least one essential oil, is capable of repelling insects and methods of using the jewelry to repel insects.

### BACKGROUND

Many people desire repellants that are free of N,N-Diethyl-meta-toluamide, or DEET, to use against insects, including mosquitos. While DEET typically is considered effective as a repellant, some users find that DEET has a strong odor, a plastic or filmy feel, requires frequent re-application, and may degrade some plastics and fabrics over time.

Repellent bracelets have become popular, but studies have shown that many do not work well, particularly the citronella oil-based bracelets. These bracelets typically are made of a coiled plastic, but they typically are suitable for only a single use that makes their disposable nature problematic, they typically are less effective than other methods, users may need to wear more than one (such as around an ankle and a wrist, or on both wrists), and these bracelets typically do not repel ticks.

Thus, there is a need for effective, DEET-free mosquito repellent jewelry.

### SUMMARY

An insect repellent system may include a jewelry item, wherein the jewelry item includes at least one bead adaptable to at least one of adsorb and absorb at least one essential oil, and wherein the at least one essential oil is capable of repelling an insect and is present in an effective amount to repel the insect. Optionally, the at least one essential oil may be at least one of partially adsorbed, partially absorbed, and combinations thereof, on the at least one bead. In some embodiments, the at least one bead may be porous, may be permeable, and may be combinations of porous and permeable.

The jewelry item may be a bracelet (for ankle or wrist), a necklace, a ring, and earring, and other types of jewelry capable of being around a user or an animal, such as a pet. (User in the context of this application will encompass both people and animals.) The jewelry item may include at least one strand coupled to the at least one bead. Optionally, the at least one strand comprises a plurality of strands. The plurality of strands or the at least one strand may be twisted. The at least one bead may comprise a plurality of beads and wherein the at least one strand couples one of the plurality of beads to an adjacent bead of the plurality of beads. The jewelry item may include a coupling mechanism configured to couple a first end of the at least one strand to a second end of the at least one strand. The at least one bead may be formed from at least one material selected from the group consisting of a wood, a coconut fiber, a porous stone, a ceramic, a plastic, a metal, and combinations thereof. The at least one bead may be formed in at least one shape selected from the group consisting of a sphere, a square, a rectangle, a toroid, an irregular shape, a diamond, a triangle, an oval, and combinations thereof.

The at least one essential oil may include a plurality of oils. For example, the at least one essential oil may be selected from the group consisting of lemon eucalyptus, lemongrass, citronella, catnip oil, gerinol, geranium oil, lavender oil, EPA registered repellents, 1-(1-methylpropoxycarbonyl)-2-(2-hydroxyethyl) piperidine (picaridin), N,N-Diethyl-meta-toluamide (DEET), and combinations thereof. Optionally, the at least one essential oil may include a lemon eucalyptus oil present in a first amount of approximately 1% to approximately 99% by volume (v/v %) and a lemongrass oil present in a second amount of approximately 99% to approximately 1% (v/v %). Optionally, the first amount of lemon eucalyptus oil may be approximately 50% (v/v %) and the second amount of lemongrass oil present may be approximately 50% (v/v %). Alternatively, the first amount of lemon eucalyptus oil may be approximately 40% (v/v %) and the second amount of lemongrass oil present may be approximately 40% (v/v %) and the at least one essential oil further may include a third amount of approximately 20% of any of the other essential oils disclosed above. For purposes of this application, approximately means plus-or-minus 10% of the amount indicated and, more preferably, plus-or-minus 5% of the amount indicated.

Embodiments of the insect repellant system may also include a dish adaptable to receive the jewelry item and the at least one essential oil. The dish may include a lid, and the lid optionally includes at least one opening. The dish may be of any desired shape, including round, square, rectangular, diamond, oval, toroidal, and other shapes and combinations thereof. The dish may be made of any desired material, including wood, plastic, ceramic, metal, and any combination thereof. The dish may include a designated portion to receive a bottle of the at least one essential oil, and that portion may optionally be raised above a bottom of the dish that receives the jewelry item and/or separated from a reservoir within the dish that receives the jewelry item.

Methods of repelling insects are also disclosed. An embodiment of the method includes applying the at least one essential oil to the jewelry item and placing the jewelry item essential oils proximate to a user's skin. The method may further include placing any of the embodiments of the jewelry item disclosed herein in a dish. The method may further include at least partially covering the jewelry with the at least one essential oil. The method may further include at least one of adsorbing and absorbing at least a portion of the at least one essential oil at least one of into and onto the at least one bead.

Another method of repelling insects may include placing any of the embodiments of the jewelry item disclosed herein in a dish, applying the at least one essential oil to the jewelry item, and placing the dish in an area to repel at least one insect from the area. The method may further include at least partially covering the jewelry with the at least one essential oil.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1A is an embodiment of a jewelry item.

FIG. 1B is another view of the embodiment of the jewelry item in FIG. 1A.

FIG. 2A is a top view of an embodiment and a design of a dish and a lid adapted to receive a jewelry item and at least one essential oil.

FIG. 2B is a side view of the lid of FIG. 2A.

FIG. 2C is a top view of an inside of the dish of FIG. 2A.

FIG. 2D is a side view of the dish of FIG. 2A.

FIG. 2E is a side view of the lid and dish of FIG. 2A.

FIG. 2F is a cross-section view of the lid and dish of FIG. 2A with a bottle of the at least one essential oil held therein.

FIG. 2G is a cross-section view of the dish of FIG. 2F without the bottle of the at least one essential oil held therein.

FIG. 2A′ is a top view of another embodiment of a decorative design of a dish and a lid adapted to receive a jewelry item and at least one essential oil, which is identical to the dish and the lid of FIGS. 2A-2G but for the lid of FIG. 2A′ is not part of the claimed design.

FIG. 2B′ is a side view of the lid of FIG. 2A′.

FIG. 2C′ is a top view of an inside of the dish of FIG. 2A′.

FIG. 2D′ is a side view of the dish of FIG. 2A′.

FIG. 2E′ is a side view of the lid and dish of FIG. 2A′.

FIG. 2F′ is a cross-section view of the lid and dish of FIG. 2A′ with a bottle of the at least one essential oil held therein for illustrative purposes, and the bottle is not part of the claimed design.

FIG. 2G′ is a cross-section view of the dish of FIG. 2F′ without the bottle of the at least one essential oil held therein.

FIG. 3A is a perspective view of another embodiment of the jewelry item positioned within an embodiment of a dish adapted to receive the jewelry item and a bottle of the at least one essential oil positioned with the dish.

FIG. 3B is a perspective view of another embodiment of a dish adapted to receive a jewelry item and a bottle of the at least one essential oil.

FIG. 4 illustrates Chart 1, which discloses the efficacy of the at least one essential oil that includes the lemon eucalyptus oil in a first amount of approximately 50% by volume (v/v %) and the lemongrass oil in a second amount of approximately 50% versus a control group of acetone.

The drawings are not necessarily to scale.

### DETAILED DESCRIPTION

Embodiments of the invention are directed to insect repellent jewelry. In various embodiments, effective oils and a design that increases adsorption and absorption may increase efficacy.

In an embodiment, unfinished wood beads are used in crocheted jewelry with essential oils and placed in a ceramic diffuser. In some embodiments, porous and/or permeable stones or ceramics may be used instead of wood beads. The essential oils may include, but are not limited to lemongrass, lemon eucalyptus, and combinations thereof. Other oils used may include citronella, catnip oil, gerinol, geranium oil, lavender oil, and combinations thereof. In some embodiments, Picaridin is added to enable tick-repellent properties.

In some embodiments, a repellent system may include a jewelry item, a ceramic dish, and essential oils. In an exemplary embodiment, the jewelry item may be worn with a layer of essential oils to repel insects. In another exemplary embodiment, a ceramic dish may be used to disseminate essential oils and repel insects in a small area.

Jewelry Item

In some embodiments, the jewelry item may include at least one of bracelets, anklets, necklaces, rings, earrings, and combinations thereof.

In an embodiment, the jewelry may include wood or coconut fiber beads. The species of wood may be any wood that will at least partially adsorb, absorb, and combinations thereof, the essential oils. One benefit of a high surface to volume ratio is to preferentially have adsorption over absorption, since it is the surface layer of oil that will contribute to the vapor pressure needed for effective repellent properties. Absorption may increase the oils available to replace surface oils, thereby serving as a reservoir of oils to lengthen wear time between applications. In some embodiments, the oils are at least one of partially absorbed, partially adsorbed, and combinations thereof by the beads. In exemplary embodiments, the jewelry may include about 3-5 mm unfinished wood or coconut fiber beads to maximize surface area and porosity to absorb and adsorb essential oils. In an embodiment, the wood species is pine of any variety of species, as well as any other species of wood. A thread of any color may be used to string the beads together. In some embodiments, a dark colored cotton thread (e.g. #20 or #10) may be utilized to string the beads together. In some embodiments, the thread material may be silk, hemp, cotton, other natural fibers, synthetic fibers, and combinations thereof. In exemplary embodiments, a spiral crochet design may be used to further increase surface-to-volume ratio for adsorption. Additionally, in certain embodiments, nickel-free clasp and logo tags may be used to prevent irritation in nickel-sensitive individuals. Further, in many embodiments, additional decorative beads with or without finishes may be used for appearances.

Dish

In embodiments according to the disclosure, the dish may be a base designed to hold jewelry item and a bottle of essential oils. In some embodiments, the dish includes a lid with at least one opening, such as a slit, to serve as a diffuser, allowing repellent effects in a small area (e.g. by a bed). The dish may be constructed of ceramic, plastic, metal, wood, and other such materials. Optionally, the dish may be coated with a glaze or sealant, which may in turn be food-safe.

In some embodiments, the dish serves as vessel to hold essential oils that may be applied to the jewelry when the jewelry is in contact with the dish and/or the oils in the dish.

In certain embodiments, after the jewelry is placed in the dish containing essential oils, the dish serves as a diffuser, thereby facilitating repellent effects in a small area. In exemplary embodiments, the dish is covered with a lid including at least one opening, thereby allowing the dish to serve as a diffuser of repellent oils into the surrounding area.

Essential Oils

The jewelry according to embodiments of the invention may be used with essential oils and other oils. In some embodiments, the essential oils are at least one selected from lemon eucalyptus, lemongrass, and combinations thereof. Other oils useful may include citronella, catnip oil, gerinol, geranium oil, lavender oil, and combinations thereof. In several embodiments, the essential oils are EPA registered repellents. In some embodiments, the essential oils may be blended with 1-(1-methylpropoxycarbonyl)-2-(2-hydroxyethyl) piperidine (commonly known as picaridin) and/or N,N-Diethyl-meta-toluamide (DEET) to increase mosquito repellant properties and add tick repellent properties. In an embodiment, the lemon eucalyptus oil is present in an amount in the range of about 1% to about 99% by volume (v/v %) and the lemongrass oil is present in an amount of about 99% to about 1% (v/v %). The composition of essential oils used may be determined by skin reactions to various blends. In an exemplary embodiment, approximately 50% lemon eucalyptus and approximately 50% lemongrass oils (v/v %) are blended for mosquito repellent. In another embodiment, approximately 40% lemon eucalyptus, approximately 40% lemongrass, and approximately 20% (v/v %) of any of the other essential oils disclosed above (singly or in combination to achieve approximately 20%) may be blended.

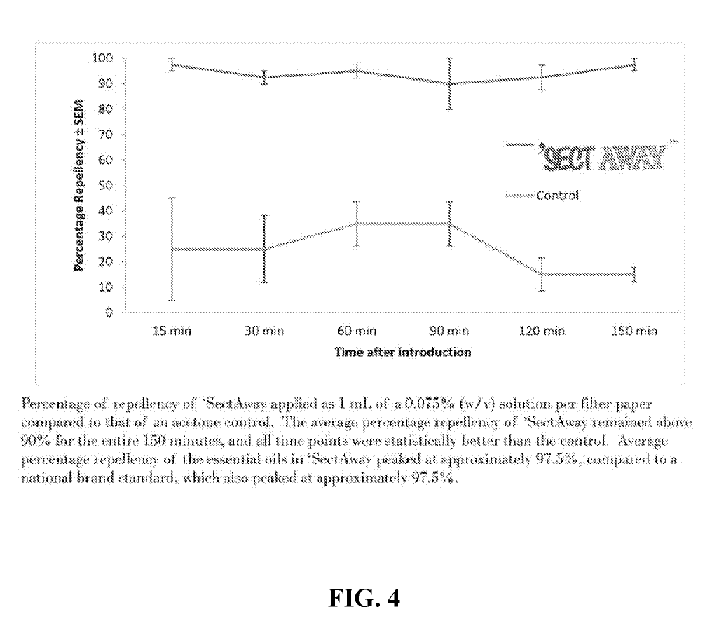

Chart 1 at FIG. 4 discloses the efficacy of the at least one essential oil that includes the lemon eucalyptus oil in a first amount of approximately 50% by volume (v/v %) and the lemongrass oil in a second amount of approximately 50% versus a control group of acetone. One milliliter of 0.075% (w/v) solution is applied to filter paper and compared to a control for repellency for 150 minutes. As chart 1 demonstrates, the essential oil is significantly more effective than a control and compares favorably with commercial repellants. 'SECTAWAY™ is the trademark for the variety of formulations of the disclosed at least one essential oil and is owned by the Applicant of the present application, Wood Originals, LLC of Bremerton, Wash.

In addition to a jewelry item, ceramic dish, and essential oils, some embodiments may further include a dropper bottle. The dropper bottle may be of a size that fits the ceramic dish and may be constructed of a material that is compatible with the essential oils. The dropper in the bottle may be used to remove the essential oils from the ceramic dish to apply the essential oil to the jewelry item or to the dish as described below. The dropper may be integrated into a cap, such as a threaded cap to seal the bottle, thereby allowing transportation of the bottle and/or to a different location without spilling the essential oils (e.g., in a pocket while hiking).

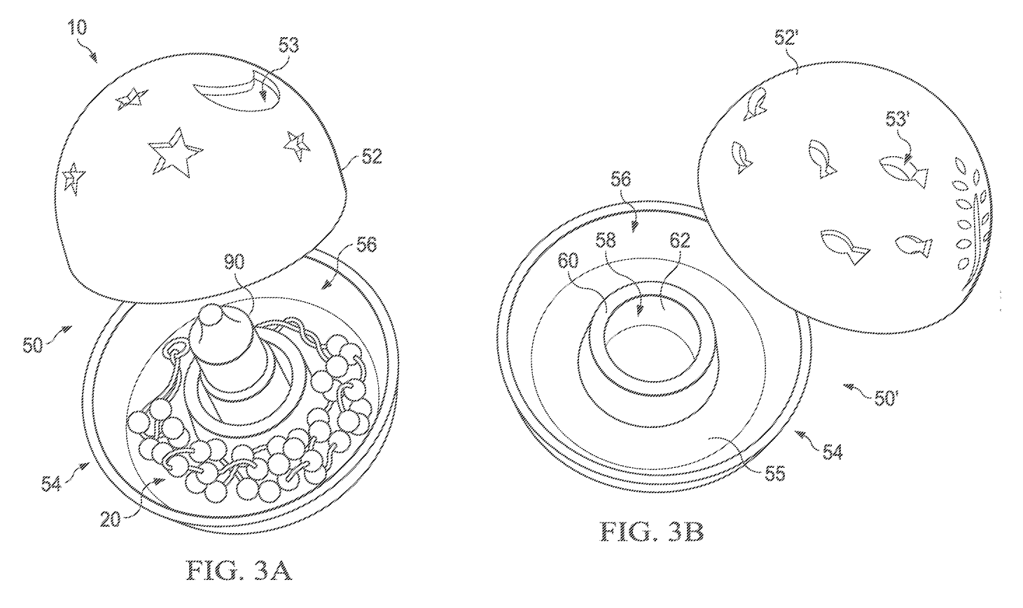

Turning to the figures, an insect repellent system 10 may include a jewelry item, a dish 50, and a least one essential oil held within a bottle or dropper bottle 90, as illustrated in FIG. 3A.

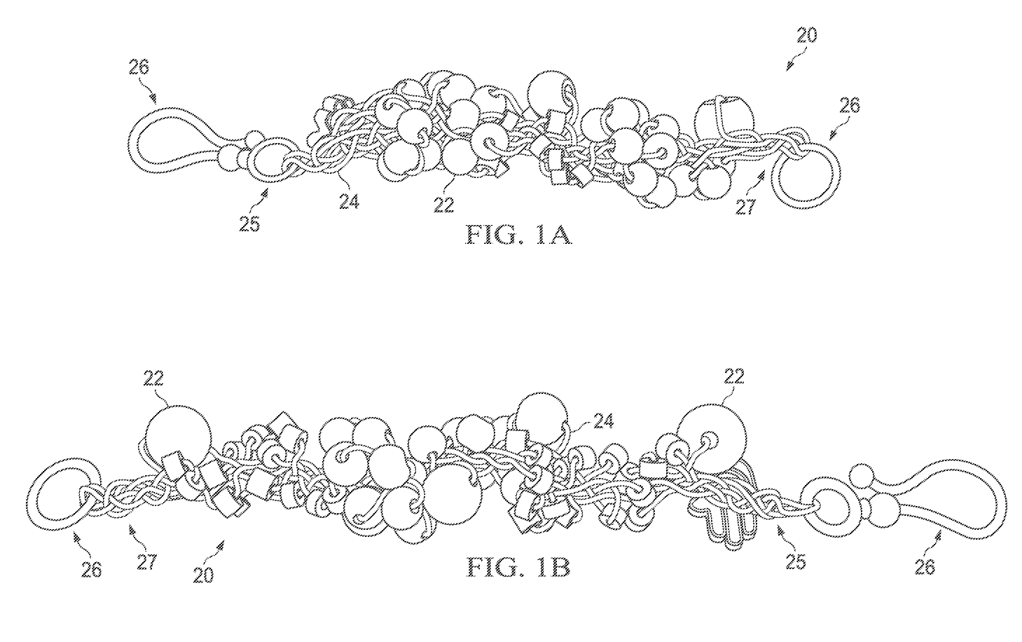

Turning to FIGS. 1A and 1B, the jewelry item 20 may be of any time of jewelry, including bracelets, anklets (bracelets worn about a user's ankle), necklaces, chains, rings, earrings, and other types of jewelry to be worn on or about a user's body. The jewelry item 20 may include at least one bead 22 adaptable to at least one of adsorb and absorb at least one essential oil as discussed below. The at least one bead 22 is capable of at least one of partially adsorbing, partially absorbing, and combinations thereof, the at least one essential oil. In some embodiments, the at least one bead 22 may be porous, may be permeable, and may be combinations of porous and permeable such that the at least one essential oil may be retained on and/or within the at least one bead 22. The at least one bead 22 may be formed from at least one material selected from the group consisting of a wood, a coconut fiber, a porous stone, a ceramic, a plastic, a metal, and combinations thereof. The at least one bead 22 may be formed in at least one shape selected from the group consisting of a sphere, a square, a rectangle, a toroid, an irregular shape, a diamond, a triangle, an oval, and combinations thereof.

The jewelry item 20 may include at least one strand 24 coupled to the at least one bead 20. Optionally, the at least one strand 24 may include a plurality of strands 24 and/or the at least one strand 24 is twisted, which increases the surface area of the at least one strand 24. The at least one strand 24 may also be capable of at least one of partially adsorbed, partially absorbed, and combinations thereof, the at least one essential oil. As noted, above, the at least one strand 24 may be made from any type of fiber (cotton, hemp, silk, synthetic or natural fibers), metals, elastic or stretchable fabrics, or other materials. For example, the at least one strand 24 may be crocheted in a twisted and/or looped manner from cotton.

The at least one bead 22 may comprise a plurality of beads. Optionally, the at least one strand 24 couples one of the plurality of beads 22 to an adjacent bead of the plurality of beads 22.

The jewelry item 20 may include a coupling mechanism 26 configured to couple a first end 25 of the at least one strand 24 to a second end 27 of the at least one strand 24. The coupling mechanism may include a hook and loop or ring, a clasp, a hasp, threaded connectors, and other known connectors. The coupling mechanism 26 may be formed of wood, plastic, metal, and the like.

The at least one essential oil is capable of repelling an insect and is present in an effective amount to repel the insect. The at least one essential oil may be provided in a bottle 90 (FIG. 3), which may include a dropper integrated into a threaded cap to receive and to dispense the essential oil. The at least one essential oil may include a plurality of oils. For example, the at least one essential oil may be selected from the group consisting of lemon eucalyptus, lemongrass, citronella, catnip oil, gerinol, geranium oil, lavender oil, EPA registered repellents, 1-(1-methylpropoxycarbonyl)-2-(2-hydroxyethyl) piperidine (picaridin), N,N-Diethyl-meta-toluamide (DEET), and combinations thereof. Optionally, the at least one essential oil may include a lemon eucalyptus oil present in a first amount of about 1% to about 99% by volume (v/v %) and a lemongrass oil present in a second amount of about 99% to about 1% (v/v %). Optionally, the first amount of lemon eucalyptus oil may be approximately 50% (v/v %) and the second amount of lemongrass oil present may approximately 50% (v/v %). Alternatively, the first amount of lemon eucalyptus oil may be approximately 40% (v/v %) and the second amount of lemongrass oil present may be approximately 40% (v/v %) and the at least one essential oil further may include a third amount of approximately 20% (v/v %) of any of the other essential oils disclosed above individually or in combination.

Embodiments of the insect repellant system 10 may also include a dish 50 adaptable to receive the jewelry item 10 and the at least one essential oil as a liquid and, optionally, as stored in the bottle 90. The dish 50 may be of any desired shape, including round, square, rectangular, diamond, oval, toroidal, and other shapes and combinations thereof. The dish 50 may be made of any desired material, including wood, plastic, ceramic, metal, and any combination thereof.

Referring first to FIG. 3A, the dish 50 may include a lid 52, and the lid 52 optionally includes at least one opening 53. The at least opening 53 may include a plurality of openings. The shape of the at least one opening 53 may be of any desired shape, including decorative shapes, such as the moon and stars illustrated in FIG. 3A. As another example, FIG. 3B illustrates a dish 50′ that is identical to the dish 50, but the lid 52′ in FIG. 3B includes another example of at least one opening 53′ that are in the shape of fish and seaweed.

The dish 50 includes a base 54 adapted to receive a portion or amount of the at least one essential oil within a reservoir 56. The reservoir 56 also is adapted to receive the jewelry item 20. In this way, the jewelry item 20 may be exposed to the at least one essential oil. For example, the at least one essential oil may at least partially and, optionally, fully immerse the jewelry item 20 so that the jewelry item 20 and, more particularly, the at least one bead 22 and/or the at least one strand 26 may at least one of absorb and/or adsorb the at least one essential oil.

While the base 54 may simply be a bowl or other receptacle shape, the base 54 may include a portion 58 configured to receive the bottle 90 of the at least one essential oil. The portion 58 may optionally be separated from the reservoir 56 by a wall 60, thereby preventing the bottle 90 from being in contact with an essential oil placed within the reservoir 56. The potion 58 may include a bottom 62 upon which the bottle 90 may rest. The bottom 62 may be raised relative to a floor 55 of the base 54.

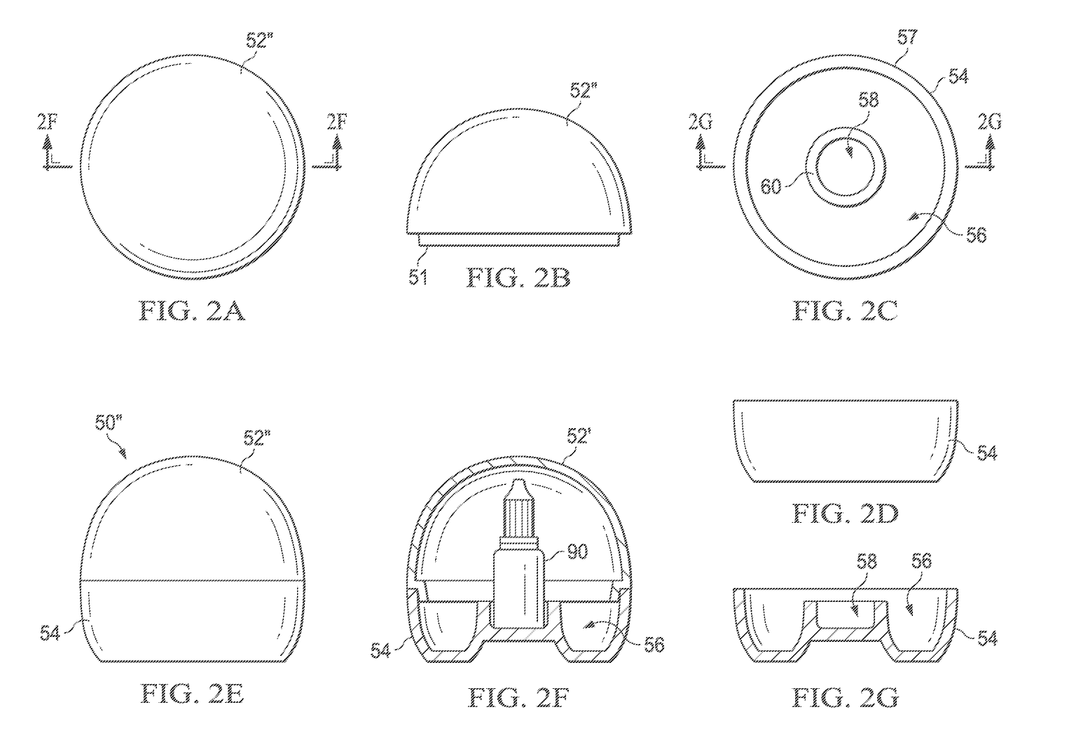

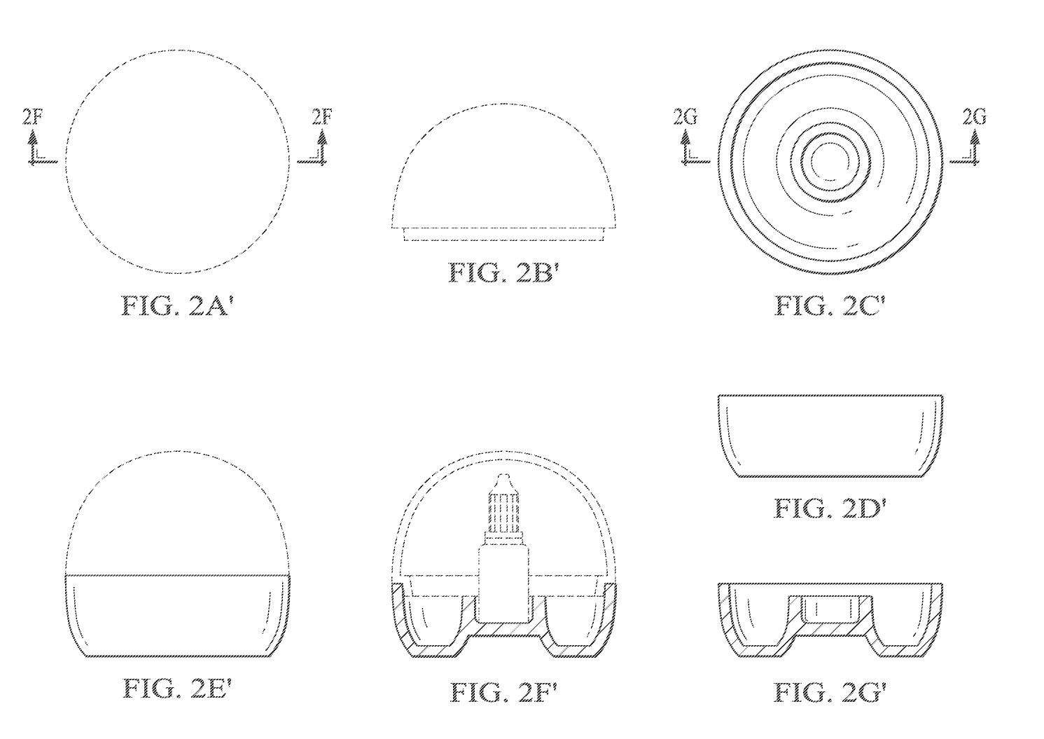

Illustrated in FIGS. 2A-2F is a decorative design of a dish 50″ that is similar in most respects to the dish 50 and dish 50′ in FIGS. 3A and 3B. The base 54 is identical in FIGS. 2A-2F with the like element numbers indicating identical components amongst the various figures. The lid 52″ includes a lip 51 (FIG. 2B) that is of a reduced dimension—diameter in this instance—that the max dimension of the lid 52″ and an inner dimension of a wall 57 of the dish 54. The lids 52 and 52′ optionally include the lip 51, which is not illustrated in FIGS. 3A and 3B. The lip 51 may help position and retain the lid 52″ atop the base 54.

While the lid 52″ may include openings such as the openings 53 and 53′ as illustrated in FIGS. 3A and 3B, such openings are not illustrated in FIGS. 2A-2F simply because the openings are not part of the decorative design disclosed in the figures. Rather, the decorative design of the lid 52″ is the outer dimensional shape of the lid 52″ itself.

Illustrated it FIGS. 2A′-2F′ is a decorative design of a dish 50″ that is identical in every respect to that in FIGS. 2A-2F with the exception being that the lid 52″ and the bottle 90 are not part of the claimed decorative design. The element numbers have not been included in FIGS. 2A′-2F′ for clarity of the decorative design and because all of the identical element numbers already are present in FIGS. 2A-2F. Consequently, the lid 52″ and the bottle 90 are drawn in dotted lines to illustrate that they are not part of the claimed decorative design and are merely presented to provide environmental context. Instead, the only portion of the decorative design claimed in FIGS. 2A′-2F′ is the base 54 as illustrated in solid lines in FIGS. 2C, 2D, 2E, 2F, and 2G. Of course, the cross-hatching denoting the cross-section is not part of the claimed design, but merely helps disclose the shape of the portion 58 that is configured to receive the bottle 90.

Methods of repelling insects are also disclosed. An embodiment of the method includes applying the at least one essential oil to the jewelry item and placing the jewelry item proximate to a user's skin. The method may further include placing any of the embodiments of the jewelry item disclosed herein in a dish. The method may further include at least partially covering the jewelry with the at least one essential oil. The method may further include at least one of adsorbing and absorbing at least a portion of the at least one essential oil at least one of into and onto the at least one bead.

Another method of repelling insects may include placing any of the embodiments of the jewelry item disclosed herein in a dish, applying the at least one essential oil to the jewelry item, and placing the dish in an area to repel at least one insect from the area. The method may further include at least partially covering the jewelry with the at least one essential oil.

The one or more present inventions, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An insect repellent system comprising:
a jewelry item, wherein the jewelry item includes at least one bead adaptable to at least one of adsorb and absorb at least one essential oil; and,
wherein the at least one essential oil is capable of repelling an insect and is present in an effective amount to repel the insect.

2. The insect repellant system of claim 1, wherein the at least one essential oil is at least one of partially adsorbed, partially absorbed, and combinations thereof, on the at least one bead.

3. The insect repellant system of claim 1, wherein the at least one bead is porous.

4. The insect repellant system of claim 1, wherein the at least one bead is permeable.

5. The insect repellant system of claim 1, wherein the at least one essential oil is selected from the group consisting of lemon eucalyptus, lemongrass, citronella, catnip oil, gerinol, geranium oil, lavender oil, EPA registered repellents, 1-(1-methylpropoxycarbonyl)-2-(2-hydroxyethyl) piperidine (picaridin), N,N-Diethyl-meta-toluamide (DEET), and combinations thereof.

6. The insect repellant system of claim 1, wherein the at least one essential oil includes a lemon eucalyptus oil present in a first amount of about 1% to about 99% by volume (v/v %) and a lemongrass oil present in a second amount of about 99% to about 1% (v/v %).

7. The insect repellant system of claim 6, wherein the first amount of lemon eucalyptus oil is approximately 50% (v/v %) and the second amount of lemongrass oil present is approximately 50% (v/v %).

8. The insect repellant system of claim 6, wherein the first amount of lemon eucalyptus oil is approximately 40% (v/v %) and the second amount of lemongrass oil is approximately 40% (v/v %) and the at least one essential oil further comprises a third amount of approximately 20% (v/v %) selected from the group consisting of citronella, catnip oil, gerinol, geranium oil, lavender oil, EPA registered repellents, 1-(1-methylpropoxycarbonyl)-2-(2-hydroxyethyl) piperidine (picaridin), N,N-Diethyl-meta-toluamide (DEET), and combinations thereof.

9. The insect repellant system of claim 1, further comprises at least one strand coupled to the at least one bead.

10. The insect repellant system of claim 9, wherein the at least one bead comprises a plurality of beads and wherein the at least one strand couples one of the plurality of beads to an adjacent bead of the plurality of beads.

11. The insect repellant system of claim 9, wherein the at least one strand comprises a plurality of strands.

12. The insect repellant system of claim 9, wherein the at least one strand is twisted.

13. The insect repellant system of claim 9, further comprising a coupling mechanism configured to couple a first end of the at least one strand to a second end of the at least one strand.

14. The insect repellant system of claim 1, wherein the at least one bead is formed from at least one material selected from the group consisting of a wood, a coconut fiber, a porous stone, a ceramic, a plastic, a metal, and combinations thereof.

15. The insect repellant system of claim 1, wherein the at least one bead is formed in at least one shape selected from the group consisting of a sphere, a square, a rectangle, a toroid, an irregular shape, a diamond, a triangle, an oval, and combinations thereof.

16. The insect repellant system of claim 1, further comprising a dish adaptable to receive the jewelry item and the at least one essential oil.

17. The insect repellant system of claim 16, wherein the dish further comprises a lid with at least one opening.

18. A method of repelling insects comprising:
applying the at least one essential oil to the jewelry item; and,
placing the jewelry item proximate to a user's skin.

19. The method of repelling insects of claim 16, further comprising placing the jewelry item of claim 1 in a dish.

20. A method of repelling insects comprising:
placing the jewelry item of claim 1 in a dish;
applying the at least one essential oil to the jewelry item; and,
placing the dish in an area to repel at least one insect from the area.
